(19) United States
(12) Patent Application Publication
(10) Pub. No.: US 2021/0097530 A1
(43) Pub. Date: Apr. 1, 2021

(54) BLOCK CHAIN TRADING SYSTEM AND BLOCK CHAIN TRADING METHOD

(71) Applicant: XAC AUTOMATION CORP., Hsinchu County (TW)

(72) Inventor: Yeng-Ming CHANG, Hsinchu County (TW)

(21) Appl. No.: 17/042,094

(22) PCT Filed: Mar. 28, 2018
(86) PCT No.: PCT/CN2018/080773

§ 371 Date: Sep. 26, 2020

(51) Int. Cl. G06Q 20/38; G06Q 20/36; H04L 9/06; G06Q 20/10

(52) U.S. Cl. CPC G06Q 20/385; G06Q 20/3825; G06Q 20/36; H04L 2209/56; G06Q 20/108; H04L 2209/38; H04L 9/0643

(57) ABSTRACT

A block chain trading system includes a block chain platform coupled to a first bank end and a second bank end. When the block chain platform receives a token obtaining request from a user end, the block chain platform actives a token to the user end via the first bank end and records token activated information. When the block chain platform receives a token spending request from a dealer end, the block chain platform verifies the token spending request. If pass the verification, the block chain platform records token trading information. When the block chain platform receives a token liquidation request for the dealer end, the block chain platform sends token trading information to the first bank end. When the token is liquidated by the first bank end, the block chain platform records token liquidation information and retrieves the token from the dealer end.

### CROSS-REFERENCE TO RELATED APPLICATION

This application is a U.S. National Phase application of PCT/CN2018/080773 filed Mar. 28, 2018, which is herein incorporated by reference.

### BACKGROUND

### Field of Disclosure

The present disclosure relates to a block chain trading system and a block chain trading method. More particularly, the present disclosure relates to the block chain trading system and the block chain trading method applied between multiple banks.

### Description of Related Art

In the today's e-commerce trading mode, if a user wants to conduct a transaction with a dealer, this process is roughly that the user initiates the transaction (for example, using a credit card, etc.), and the dealer pulls back authorization from the user's card activating bank to conduct the transaction. In this trading mode, the dealer is the starting and ending point of the trading process.

However, in this trading mode, it is difficult for the bank end to obtain available information about the user, which makes the bank end easy to be excluded from the cycle of client participation, and the bank end needs to pay a high fee for the relay platform.

In addition, nowadays, virtual currency transactions have emerged. Although it is not a trading mode under the traditional payment structure, the virtual currency trading mode is not controlled by the supervisory agency. And this has a relatively high degree of risk.

Therefore, it is obvious that the today's e-commerce trading mode still has shortcomings regarding the above-mentioned problems, and it is urgently needed to be improved.

### SUMMARY

The disclosure provides a block chain trading method applied between a block chain platform, a first bank end and a second bank end, and the block chain trading method comprising: when the first bank end receives a token obtaining request initiated from a user end, activating a token corresponding to the user end using the block chain platform, wherein the token is sent to the user end via the first bank end; verifying the token spending request according to the token activated information corresponding to the token using the block chain platform, wherein the token activated information is recorded by the block chain platform, and the token spending request is a request initiated by the user end to a dealer end; if the token spending request is passed verification by the block chain platform, recording the token trading information corresponding to the token using the block chain platform; when the second bank end initiates a token liquidation request for the dealer end to the block chain platform, sending the token trading information to the first bank end to liquidate the token using the block chain platform; and when the first bank end liquidates the token according to the token trading information, recording the token liquidation request and retrieving the token using the block chain platform.

The disclosure provides a block chain trading system. The block chain trading system comprises a block chain platform. The block chain platform operating in a plurality of computer hosts or a plurality of servers corresponding to a plurality of nodes. The block chain platform is coupled to a first bank end and a second bank end. When the block chain platform receives a token obtaining request initiated by a user end via the first bank end, the block chain platform activates a token corresponding to the user end and records the token activated information corresponding to the token. The block chain platform receives a token spending request, wherein the token spending request is a request initiated by the user end to send the token to a dealer end. The block chain platform verifies the token spending request according to the token activated information, if the token spending request is passed verification by the block chain platform, the block chain platform records token trading information corresponding to the token. When the block chain platform receives a token liquidation request from the dealer end, the block chain platform sends the token trading information to the first bank end to liquidate the token, and the token liquidation request is initiated by the second bank end to the block chain platform. When the first bank end liquidates the token according to the token trading information, the block chain platform records the token liquidation information and retrieves the token.

Therefore, according to the technical content of the disclosure, the embodiments of the disclosure provide a block chain trading system and a block chain trading method to improve the problem that the bank end is difficult in obtaining available information in the traditional trading process, and it further ensures the security and non-repudiation of transactions between the user end and the dealer end.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram of a block chain trading system based on an embodiment of the disclosure; and

FIG. 2 is a schematic diagram of a block chain trading method based on an embodiment of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

The following will clearly illustrate the spirit of the disclosure with diagrams and detailed descriptions. Any person with ordinary knowledge in the relevant technical field, after understanding the embodiments of the disclosure, can change and modify the technology taught in the disclosure without departing from the spirit and scope of the disclosure.

The terms used herein are only to describe specific embodiments, and are not intended to limit the disclosure. Singular forms such as “one”, “this” and “the”, as used herein, also include plural forms.

Regarding “first”, “second”, etc. used in this article, it does not specifically refer to order or sequence, nor is it intended to limit the disclosure. It is only for distinguishing components or operations described in the same technical terms.

Regarding “couple” or “connect” used in this article, it can mean that two or more components or devices make physical contact with each other directly or indirectly make physical contact with each other. It can also refer to the mutual operations or actions of two or more components or devices.

Regarding “include”, “comprise”, “have”, “contain”, etc. used in this article are all open terms, which means including but not limited thereto.

Regarding “and/or” used in this article, it includes any or all combinations of the things described.

Regarding the directional terms used in this text, such as: up, down, left, right, front or back, etc., only refer to the directions of the attached drawings. Therefore, the directional terms used are used to illustrate but not to limit the disclosure.

Regarding the terms used in this article, unless otherwise specified, each term usually has the usual meaning of being used in this field, in the content of the disclosure, and in the special content. Some terms used to describe the disclosure is discussed below or elsewhere in this specification to provide those skilled in the art with additional guidance on the description of the disclosure.

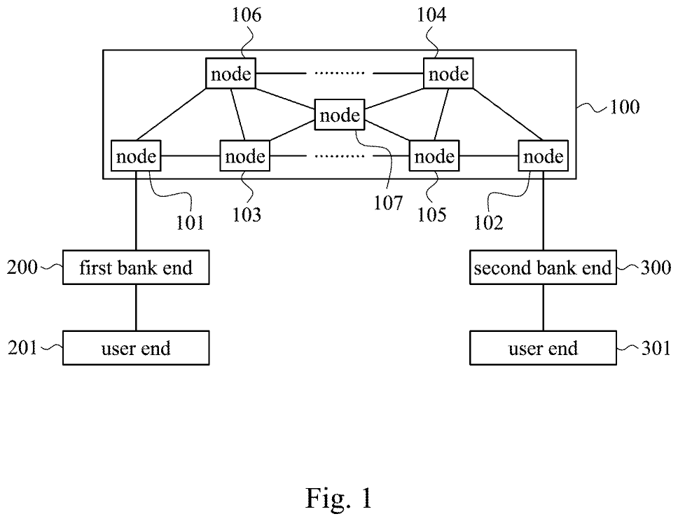

FIG. 1 is a schematic diagram of a block chain trading system based on an embodiment of the disclosure. As shown in FIG. 1, in this embodiment, a block chain platform 100 includes multiple nodes 101 to 107, and these nodes are communicatively coupled to each other. It should be noted that each of these nodes 101 to 107 is a computer host or a server, each of these nodes 101 to 107 includes singular processing unit or multiple processing units, and these processing units are electrically coupled to internal or external memory, where the internal or external memory includes volatile or non-volatile memory. The processing units of each of the nodes 101 to 107 are electrically configured to access an instruction set from the internal or external memory, and execute the instruction set to further implement the program defined by the instruction set.

Continuing to refer to FIG. 1, in this embodiment, the nodes 101 to 107 are communicatively coupled to each other, and the communication coupling referred to here may be a physical or non-physical coupling. For example, these nodes 101 to 107 may be jointly coupled to a network by wireless communication technology (for example, Wi-Fi), so as to exchange information in both directions via the network. Alternatively, these nodes 101 to 107 may be coupled to the network through physical lines to perform two-way information exchange via the network. In other words, in some implementations, under the condition that the nodes 101 to 107 are communicatively coupled to each other, the nodes 101 to 107 may be distributed in multiple different fields. These nodes 101 to 107 constitute the block chain platform 100, and these nodes 101 to 107 in the block chain platform 100 are configured to jointly verify and store the information sent between these nodes 101 to 107. It should be noted that most of these nodes 101 to 107 are each communicatively coupled to the bank end system and the node 104 which is one of these nodes 101 to 107 is the initial node for managing the communication between other nodes. In addition, these nodes 101 to 107 shown in this embodiment are only for illustration and not to limit the disclosure. The block chain platform 100 may include other nodes besides the nodes 101 to 107.

As shown in FIG. 1, in this embodiment, the node 101 is communicatively coupled to a first bank end 200, and the first bank end 200 is communicatively coupled to a user end 201. The first bank end 200 can be a backend system of the first bank, and the first bank end 200 is configured to control the account information of the clients of the first bank. The user end 201 corresponds to a user. The user is a client of the first bank and has an account with the first bank. Correspondingly, in this embodiment, the node 102 is communicatively coupled to a second bank end 300, and the second bank end 300 is communicatively coupled to a dealer end 301. The second bank end 300 may be a backend system of a second bank, and the second bank end 300 is configured to control the account information of the clients of the second bank. The dealer end 301 corresponds to a dealer. The dealer is a client of the second bank, and has an account with the second bank.

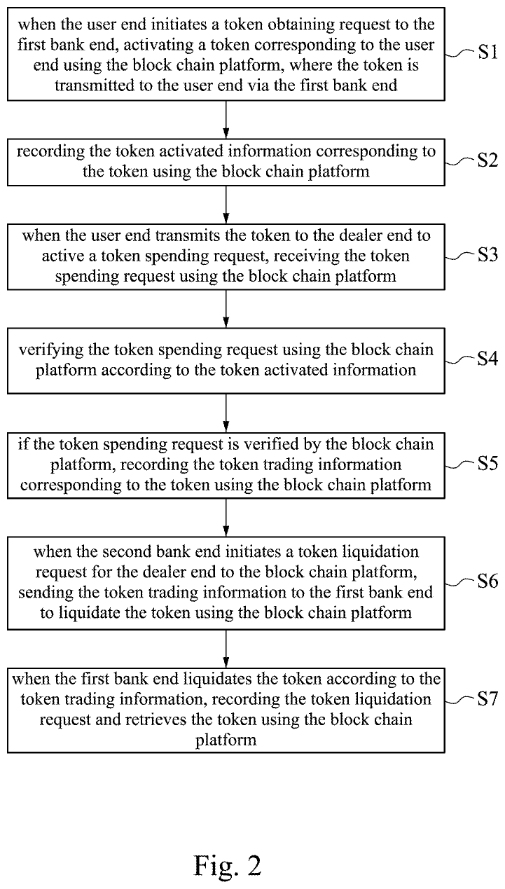

FIG. 2 is a schematic diagram of a block chain trading method based on an embodiment of the disclosure.

It should be noted that in this embodiment, the block chain trading method includes steps S1 to S7. Steps S1 to S7 are implemented by the block chain trading system in the embodiment in FIG. 1, so the implementation environment of the block chain trading method can also refer to the embodiment in FIG. 1. In this embodiment, the steps included in the block chain trading method are detailed in the following paragraphs.

Step S1: when the user end 201 initiates a token obtaining request to the first bank end 200, activating a token corresponding to the user end 201 using the block chain platform 100, where the token is sent to the user end 201 via the first bank end 200.

In this embodiment, before the user end 201 wants to conduct a transaction, the user end 201 can initiate the token obtaining request to the first bank end 200, and the token obtaining request corresponds to a quota. The first bank end 200 verifies whether the token obtaining request is feasible. If the token obtaining request is verified, the first bank end 200 may request the block chain platform 100 to activate a token corresponding to the user end 201. The token is then sent to the user end 201 via the first bank end 200.

For example, the user end 201 can initiate the token obtaining request to the first bank end 200, and the token obtaining request corresponds to a quota of 500 new Taiwan dollars (NTD). The first bank end 200 verifies whether the identity of the user end 201 is correct, and the first bank end 200 further verifies whether the account corresponding to the user end 201 is sufficient to pay the quota of 500 NTD. Or, the first bank end 200 verifies whether the credit card corresponding to the user end 201 is sufficient to pay the quota of 500 NTD. If the account or credit card corresponding to the user end 201 is sufficient to pay the quota, the token obtaining request passes the verification of the first bank end 200. After the first bank end 200 verifies the token obtaining request, the first bank end 200 requests the block chain platform 100 through the node 101 to activate the token corresponding to the user end 201, where the token is the quota of 500 NTD.

As mentioned above, when the first bank end 200 requests the block chain platform 100 to activate the token through the node 101, the block chain platform 100 transfers a virtual currency of the quota of 500 NTD from the token pool to a virtual account corresponding to the user end 201. The block chain platform 100 sends a trading code to the first bank end 200 through the node 101. The first bank end 200 generates the token according to the trading code, and then sends the token to the user end 201 for storage. It should be noted that the token contains the following information: the trading code, the quota of the token, the generating time of the token, the effective period of the token, the user identification code, the bank identification code, etc. In this way, during the effective period of the token, the user end 201 can use the token for the transaction within the quota of the token.

Step S2: recording the token activated information corresponding to the token using the block chain platform 100.

Based on the foregoing, in this embodiment, after the block chain platform 100 sends a trading code to the first bank end 200 through the node 101, the node 101 generates the token activated information corresponding to the trading code, and the token activated information may be sent to the nodes 102 to 107 in the block chain platform 100 for verification and storage. In this way, the nodes 101 to 107 in the block chain platform 100 share the token activated information. It should be noted that in this embodiment, the node 104 is the initial node, which is used to manage the communication between other nodes. In detail, the node 104 is the key manager of the nodes 101 to 107, and is used to distribute the respective keys of the nodes 101 to 107, so that the information sent between the nodes 101 to 107 is protected by point-to-point encryption (P2PE).

Therefore, in this embodiment, when the token activated information is sent to the nodes 102 to 107 in the block chain platform 100 and the token activated information is sent among the nodes 102 to 107, the contents of the token activated information are all encrypted information, and only the headers clearly indicate the transmission paths of the token activated information. When the token activated information reaches the target node among the nodes 102 to 107, the target node can use the key to decrypt the token activated information, and then verify and store the token activated information.

Step S3: when the user end 201 sends the token to the dealer end 301 to activate a token spending request, receiving the token spending request using the block chain platform 100.

Based on the foregoing, in this embodiment, after the user end 201 stores the token, during the effective period of the token, the user end 201 can use the token to conduct the transaction within the quota of the token. If the user end 201 wants to conduct the transaction of a specific quota with the dealer end 301, the user end 201 can send the token to the dealer end 301 to initiate the token spending request. For example, in one embodiment, when the user end 201 wants to conduct the transaction of a quota of 200 NTD with the dealer end 301, the dealer end 301 can send the token spending request to the second bank end 300, and the second bank end 300 sends the token spending request to the node 102 in the block chain platform 100.

Step S4: verifying the token spending request using the block chain platform 100 according to the token activated information.

Following the foregoing, in this embodiment, after the node 101 receives the token spending request, the node 101 may verify the token spending request according to the token activated information. For example, the node 101 can verify the authenticity of the token based on information such as the effective period of the token, the user identification code, and the trading code. Further, the node 101 can determine whether the transaction between the user end 201 and the dealer end 301 is feasible according to the quota of the token. As mentioned above, the user end 201 wants to conduct the transaction of the quota of 200 NTD with the dealer end 301, and the quota of the token is 500 NTD, so the token spending request is feasible. The token spending request can be verified by the node 101.

Step S5: if the token spending request is verified by the block chain platform 100, recording the token trading information corresponding to the token using the block chain platform 100.

Based on the foregoing, in this embodiment, the token spending request can be verified by the node 101, and the node 101 generates the token trading information, which indicates the trading content between the user end 201 and the dealer end 301, and the node 101 sends the token trading information to the other nodes 102 to 107, and the nodes 102 to 107 verify and store the token trading information.

For example, in this embodiment, the token trading information indicates that the user end 201 and the dealer end 301 conduct the transaction of the quota of 200 NTD. After the token trading information is verified and stored by the nodes 102 to 107, the transaction is established. Similarly, when the token trading information is sent between nodes in the block chain platform 100, the token trading information is protected by peer-to-peer encryption.

It should be noted that, in this embodiment, because the user end 201 and the dealer end 301 conduct the transaction of the quota of 200 NTD, after the transaction of 200 NTD is established, the token may only remain a quota of 300 NTD during the effective period of the token. During the effective period of the token, the user end 201 can then conduct the transaction with the dealer end 301 or other dealer ends based on the token, but the quota of the transaction should be lower than the quota of the token. Otherwise, when the node 101 verifies a token spending request that exceeds the remaining quota of the token, the token spending request may not be verified, and the transaction may not be established.

Step S6: when the second bank end 300 initiates a token liquidation request for the dealer end 301 to the block chain platform 100, sending the token trading information to the first bank end 200 to liquidate the token using the block chain platform 100.

In this embodiment, the second bank end 300 can initiate the token liquidation request on the dealer end 301 to the block chain platform 100, and the token liquidation request is used to liquidate the trading records of the dealer end 301 in the block chain platform 100, so that the dealer end 301 can receive payment corresponding to the trading records. For example, in this embodiment, when the first bank end 200 initiates the token liquidation for the dealer end 301 to the block chain platform 100 via the node 102, the block chain platform 100 searches the nodes 101 to 107 to obtain trading records of the dealer end 301 in a specific time interval. In this way, the block chain platform 100 can obtain the token trading information about the dealer end 301, and the block chain platform 100 can send the token trading information to the first bank end 200 via the node 101.

Step S7: When the first bank end 200 liquidates the token according to the token trading information, recording the token liquidation request and retrieves the token using the block chain platform 100.

As mentioned above, in this embodiment, when the block chain platform 100 receives the token liquidation request for the dealer end 301, the block chain platform 100 can send the token trading information to the first bank end 200 via the node 101. According to the token trading information, the first bank end 200 can liquidate the token. For example, in this embodiment, the token trading information records that the user end 201 has conducted the transaction of the quota of 200 NTD with the dealer end 301. The first bank end 200 can liquidate the token based on the transaction of the quota of 200 NTD. Further, the first bank end 200 can transfer 200 NTD in cash from the account corresponding to the user end 201 to the account corresponding to the dealer end 301. After the first bank end 200 liquidates the token, the first bank end 200 generates the token liquidation information. The first bank end 200 sends the token liquidation information to the block chain platform 100 via the node 101, and the nodes 101 to 107 in the block chain platform 100 can verify and record the token liquidation information. Similarly, when the token liquidation information is sent between nodes in the block chain platform 100, the token spending request is protected by peer-to-peer encryption.

It should be noted that after the nodes 101 to 107 in the block chain platform 100 verify and record the token liquidation information, the second bank end 300 can obtain the token liquidation information through the node 102. The second bank end 300 can liquidate the token received by the dealer end 301 from the user end 201. Based on the foregoing, the dealer end 301 and the user end 201 used to conduct the transaction of the quota of 200 NTD based on the token. However, when the first bank end 200 liquidated the token, the first bank end 200 has transferred 200 NTD in cash from the account corresponding to the user end 201 to the account corresponding to the dealer end 301 in the second bank end 300. Therefore, since the cash corresponding to the token trading information has been transferred to the account of the dealer end 301, the second bank end 300 can liquidate the token received by the dealer end 301 from the user end 201. The quota of 200 NTD of the token may be retrieved into the token pool of the block chain platform 100.

As mentioned above, when the second bank end 300 liquidates the token, the used quota in the token may be retrieved. In detail, the original quota of the token on the user end 201 is 500 NTD. After the first bank end 200 and the second bank end 300 complete the liquidation, the remaining quota of the token on the user end 201 is 300 NTD. That is, during the effective period of the token, the user end 201 can use the token to conduct the transaction which quota is less than 300 NTD with the dealer end 301 or other dealer ends.

It should be noted that in some embodiments, if the user end 201 and the dealer end 301 both communicate with the same bank end (for example, the first bank end 200), the above-mentioned processes of the token obtaining, the token trading, token liquidating, etc. can all be completed by the first bank end 200 and the block chain platform 100.

In view of the authorization request mode of the prior art, it is difficult for the bank to obtain the available information about the user, which makes the bank easy to be excluded from the cycle of client participation, and the bank has to pay a high fee for the relay platform. However, it can be seen from the above implementation of the disclosure that the disclosure provides an effective block chain trading system and method. By connecting the block chain platform to multiple bank ends, users only need to authorize once to the bank end, which can realize the mutual conversion of cash and virtual currency in the accounts of users and dealers, so that conduct virtual currency transactions or liquidating. The trading process of users and dealers are verified and stored by multiple nodes in the block chain platform, which further ensures the security and non-repudiation of transactions between the user and dealers. In addition, compared with the prior art, the disclosure also ensures that the bank end can obtain available information about the user during the trading process, so that the bank end is no longer excluded from the cycle of client participation.

In other embodiments, the aforementioned method in FIG. 2 can be implemented as a computer program product (such as an application program) and stored in a computer readable recording medium, so that the computer reads the recording medium and executes the method shown in FIG. 2. The computer-readable recording medium can be read-only memory, flash memory, floppy disk, hard disk, optical disk, flash drive, tape, a database accessible by the network or a computer-readable recording medium with the same function that can be easily thought of by those familiar with the art.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A block chain trading method applied between a block chain platform, a first bank end and a second bank end, and the block chain trading method comprising:
when the first bank end receives a token obtaining request initiated from a user end, activating a token corresponding to the user end using the block chain platform, wherein the token is sent to the user end via the first bank end;
verifying the token spending request according to the token activated information corresponding to the token using the block chain platform, wherein the token activated information is recorded by the block chain platform, and the token spending request is a request initiated by the user end to a dealer end;
if the token spending request is passed verification by the block chain platform, recording the token trading information corresponding to the token using the block chain platform;
when the second bank end initiates a token liquidation request for the dealer end to the block chain platform, sending the token trading information to the first bank end to liquidate the token using the block chain platform; and
when the first bank end liquidates the token according to the token trading information, recording the token liquidation request and retrieving the token using the block chain platform.

2. The block chain trading method of claim 1, wherein the block chain platform comprises a plurality of nodes, when the block chain platform records the token activated information, the token trading information, and the token liquidation information, the token activated information, the token trading information, and the token liquidation information is sent to the plurality of nodes for verification and storage through peer-to-peer encryption protection.

3. The block chain trading method of claim 1, wherein
the token has a total quota and an effective period,
if the token spending request verified by the block chain corresponds to a first quota, the token has a second quota during effective period, and the second quota is equal to the total quota minus the first quota.

4. The block chain trading method of claim 3, further comprising:
when the effective period expires, retrieving the token using the block chain platform, and returning the second quota to a user end account corresponding to the user end using the first bank end.

5. The block chain trading method of claim 3, further comprising:
when the effective period expires, retrieving the token using the block chain platform, and deducting the first quota from a user end account corresponding to the user end using the first bank end.

6. The block chain trading method of claim 3, further comprising:
when the first bank end liquidates the token according to the token trading information, the first bank end transfers the first quota from a user account corresponding to the user end to a dealer end account corresponding to the dealer end.

7. A block chain trading system, comprising:
a block chain platform operating in a plurality of computer hosts or a plurality of servers corresponding to a plurality of nodes, wherein the block chain platform is coupled to a first bank end and a second bank end,
wherein, when the block chain platform receives a token obtaining request initiated by a user end via the first bank end, the block chain platform activates a token corresponding to the user end and records the token activated information corresponding to the token,
wherein the block chain platform receives a token spending request, wherein the token spending request is a request initiated by the user end to send the token to a dealer end,
wherein the block chain platform verifies the token spending request according to the token activated information, if the token spending request is passed verification by the block chain platform, the block chain platform records token trading information corresponding to the token,
wherein, when the block chain platform receives a token liquidation request from the dealer end, the block chain platform sends the token trading information to the first bank end to liquidate the token, and the token liquidation request is initiated by the second bank end to the block chain platform,
wherein, when the first bank end liquidates the token according to the token trading information, the block chain platform records the token liquidation information and retrieves the token.

8. The block chain trading system of claim 7, wherein, when the block chain platform records the token activated information, the token trading information, and the token liquidation information, the token activated information, the token trading information, and the token liquidation information is sent to the plurality of nodes for verification and storage through peer-to-peer encryption protection.

9. The block chain trading system of claim 7, wherein the token has a total quota and an effective period, if the token spending request verified by the block chain corresponds to a first quota, the token has a second quota during effective period, and the second quota is equal to the total quota minus the first quota.

10. The block chain trading system of claim 9, wherein, when the first bank end liquidates the token according to the token trading information, the first bank end transfers the first quota from a user account corresponding to the user end to a dealer end account corresponding to the dealer end.
